(19) United States
(12) Patent Application Publication
(10) Pub. No.: US 2026/0320988 A1
(43) Pub. Date: Oct. 15, 2026

(54) MACHINE LEARNING MODEL DIAGNOSTIC METHOD, A VEHICLE, AND A COMPUTER-READABLE STORAGE MEDIUM STORING INSTRUCTIONS FOR PERFORMING THE MACHINE LEARNING MODEL DIAGNOSTIC METHOD

(71) Applicants: HYUNDAI MOTOR COMPANY, Seoul (KR); KIA CORPORATION, Seoul (KR)

(72) Inventor: Dong Sun Kim, Hwaseong-si (KR)

(73) Assignees: HYUNDAI MOTOR COMPANY, Seoul (KR); KIA CORPORATION, Seoul (KR)

(21) Appl. No.: 19/644,369

(22) Filed: Apr. 10, 2026

(30) Foreign Application Priority Data
Apr. 10, 2025 (KR) 10-2025-0046962

(51) Int. Cl. G06V 10/776; G06V 20/56

(52) U.S. Cl. CPC G06V 10/776; G06V 20/56

(57) ABSTRACT

A machine learning model diagnostic method includes: preparing a camera-based machine learning model; generating a test image that is used as an input to the camera-based machine learning model; inputting the test image into the camera-based machine learning model; executing the camera-based machine learning model; determining test image-based result data output from the camera-based machine learning model; determining test result data corresponding to the test image; and determining a state of the camera-based machine learning model by comparing the test image-based result data with the test result data.

### CROSS-REFERENCE TO RELATED APPLICATION

This application claims priority to and the benefit of Korean Patent Application No. 10-2025-0046962, filed on Apr. 10, 2025, the disclosure of which is incorporated herein by reference in its entirety.

### TECHNICAL FIELD

The present disclosure relates to a vehicle and a control method thereof, and more particularly, to a technique for diagnosing a machine learning model used for autonomous driving.

### BACKGROUND

An autonomous vehicle can independently recognize a road environment, determine a driving situation, and travel from a current location to a target location along a planned driving route.

In this case, the autonomous vehicle uses a machine learning model for recognizing the road environment and determining the driving situation, and the machine learning model performs learning to output data necessary for recognizing the road environment and determining the driving situation by using data acquired from various sensors such as cameras, radars, and light detection and ranging (LiDAR) sensors.

### SUMMARY

A difference may occur between an environment in which the machine learning model for determining the driving situation performs learning and an environment in which the machine learning model is applied to an actual vehicle to perform inference. Even when the machine learning model for determining the driving situation outputs normal results in the learning environment, defects may occur during the process of embedding or updating the model in the vehicle, which causes the machine learning model for determining the driving situation to be altered and produce inaccurate inference results in the vehicle. When the machine learning model for determining the driving situation performs inaccurate inference in this way, it may cause serious problems, such as triggering accidents while the autonomous vehicle is in operation.

Ultimately, in order to enhance the stability of an autonomous driving system that uses a machine learning model for determining a driving situation, it is necessary to perform a diagnosis to determine whether inference is performed normally after the machine learning model for determining the driving situation is embedded or updated in the vehicle.

The present disclosure is directed to a method and a vehicle capable of diagnosing whether a machine learning model for determining a driving situation applied to a vehicle performs inference normally.

The present disclosure is also directed to a method and a vehicle capable of diagnosing whether a machine learning model for determining a driving situation is operated normally by the hardware installed in a vehicle.

The technical problems to be achieved in the present disclosure are not limited to the technical problems mentioned above, and other technical problems that have not been mentioned should be clearly understood by a person having ordinary skill in the technical field to which the present disclosure belongs from the description below.

In accordance with an aspect of the present disclosure, a machine learning model diagnostic method includes: preparing a camera-based machine learning model; generating a test image that is used as an input to the camera-based machine learning model; inputting the test image into the camera-based machine learning model; executing the camera-based machine learning model; determining or identifying test image-based result data output from the camera-based machine learning model; determining test result data corresponding to the test image; and determining a state of the camera-based machine learning model by comparing the test image-based result data with the test result data.

Determining the state of the camera-based machine learning model may include determining whether the test image-based result data is the same as the test result data.

Determining the state of the camera-based machine learning model may include: determining an error rate based on the test image-based result data and the test result data (e.g., between the test image-based result data and the test result data); comparing the determined or identified error rate with a predetermined threshold value; and determining, based on a result of comparing the determined error rate with a predetermined threshold value, the state of the camera-based machine learning model or a state of a processor that executes the camera-based machine learning model.

Determining or identifying the error rate may include: calculating a proportion of an overlapping area between an area of an object included in the test image-based result data and an area of an object included in the test result data; and determining the error rate based on the proportion of the overlapping area (e.g., determining the proportion of the overlapping area as the error rate).

The determining of the error rate may include determining the error rate based on a time required to output the test image-based result data relative to a predetermined reference required time (e.g., determining, as the error rate, a time required to output the test image-based result data relative to a predetermined reference required time).

The machine learning model diagnostic method may further include determining that the state of the camera-based machine learning model is a first state that satisfies a predetermined condition based on the error rate being greater than the predetermined threshold value.

In accordance with another aspect of the present disclosure, a vehicle comprises: a camera configured to detect a target object near a driving vehicle; a memory configured to store a machine learning model diagnostic program; and a processor, by executing the machine learning model diagnostic program, configured to: prepare a camera-based machine learning model; generate a test image that is used as an input to the camera-based machine learning model; input the test image into the camera-based machine learning model; execute the camera-based machine learning model; determine or identify test image-based result data output from the camera-based machine learning model; determine test result data corresponding to the test image; and determine a state of the camera-based machine learning model by comparing the test image-based result data with the test result data.

The processor may be further configured to determine whether the test image-based result data is the same as the test result data.

The processor may be further configured to determine or identify an error rate based on the test image-based result data and the test result data (e.g., between the test image-based result data and the test result data); and compare the determined or identified error rate with a predetermined threshold value; and determine, based on a compared result, the state of the camera-based machine learning model or a state of hardware that executes the camera-based machine learning model.

The hardware may include the processor.

The processor may be further configured to calculate a proportion of an overlapping area between an area of an object included in the test image-based result data and an area of an object included in the test result data, and determine the error rate based on the proportion of the overlapping area (e.g., determine the proportion of the overlapping area as the error rate).

The processor may be further configured to determine the error rate based on a time required to output the test image-based result data relative to a predetermined reference required time (e.g., determine, as the error rate, a time required to output the test image-based result data relative to a predetermined reference required time).

The processor may be further configured to determine that the state of the camera-based machine learning model is a first state that satisfies a predetermined condition based on the error rate being greater than the predetermined threshold value.

In accordance with another aspect of the present disclosure, a non-transitory computer-readable storage medium includes computer executable instructions. The computer executable instructions, when executed by a processor, cause the processor to perform a machine learning model diagnostic method. The method includes: preparing a camera-based machine learning model; generating a test image that is used as an input to the camera-based machine learning model; inputting the test image into the camera-based machine learning model; executing the camera-based machine learning model; determining or identifying test image-based result data output from the camera-based machine learning model; determining test result data corresponding to the test image; and determining a state of the camera-based machine learning model by comparing the test image-based result data with the test result data.

### BRIEF DESCRIPTION OF THE DRAWINGS

The above and other objects, features and advantages of the present disclosure should become more apparent to those of ordinary skill in the art by describing examples thereof in detail with reference to the accompanying drawings, in which:

FIG. 1 is a view illustrating an example of a vehicle that transmits and receives data by communicating with another device according to an example of the present disclosure;

FIG. 2 is a diagram showing an example of modules constituting a vehicle according to an example of the present disclosure;

FIG. 3 is a block diagram illustrating an example of a detailed configuration of a processor and a memory for autonomous driving control in an autonomous driving device according to an example of the present disclosure;

FIG. 4 is a diagram illustrating an example of components of a camera-based machine learning model diagnostic apparatus according to an example of the present disclosure; and

FIG. 5 is a flowchart illustrating an example of the operation of a camera-based machine learning model diagnostic method according to an example of the present disclosure.

### DETAILED DESCRIPTION

The advantages and features of the examples and the methods of accomplishing the examples should be clearly understood from the following description taken in conjunction with the accompanying drawings. However, examples are not limited to those examples described, as examples may be implemented in various forms. It should be noted that examples are provided to make a full disclosure and also to allow those having ordinary skill in the art to know the full range of examples. Therefore, examples are to be defined only by the scope of the appended claims.

Terms used in the present disclosure are briefly described, and the present disclosure is described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms is described in detail in the description of the corresponding disclosure. Therefore, the terms used in the present disclosure should be defined based on the meaning of the terms and the overall contents of the present disclosure, not just the name of the terms.

When it is described that a part in the overall disclosure “includes,” “comprises,” and/or “has” a certain component, this means that other components may be further included instead of excluding other components unless specifically stated to the contrary.

In addition, a term such as a “unit” or a “portion” used in the disclosure means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”. Further, the terms such as ‘unit’, ‘module’, and the like refer to one or more units for processing at least one function or operation, which may be implemented by hardware, software, or a combination thereof. When a component, unit, module, processor, controller, device, element, apparatus, or the like of the present disclosure is described as having a purpose or performing an operation, function, or the like, the component, unit, module, processor, controller, device, element, apparatus, or the like should be considered herein as being “configured to” meet that purpose or to perform that operation or function. Each component, unit, module, processor, controller, device, element, apparatus, and the like may separately embody or be included with a processor and a memory, such as a non-transitory computer readable media, as part of the apparatus.

Hereinafter, one or more examples of the present disclosure are described in detail with reference to the accompanying drawings so that those of ordinary skill in the art may easily implement the present disclosure. In the drawings, portions not related to the description are omitted in order to clearly describe the present disclosure.

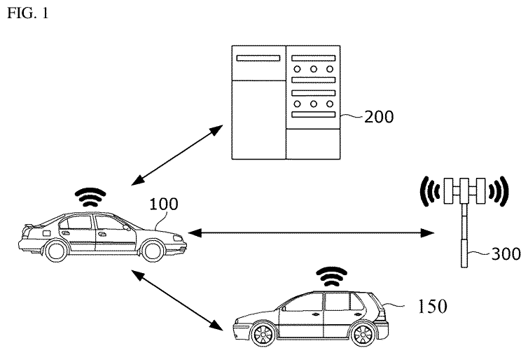

FIG. 1 is a view illustrating an example of a vehicle that transmits and receives data by communicating with another device according to an example of the present disclosure.

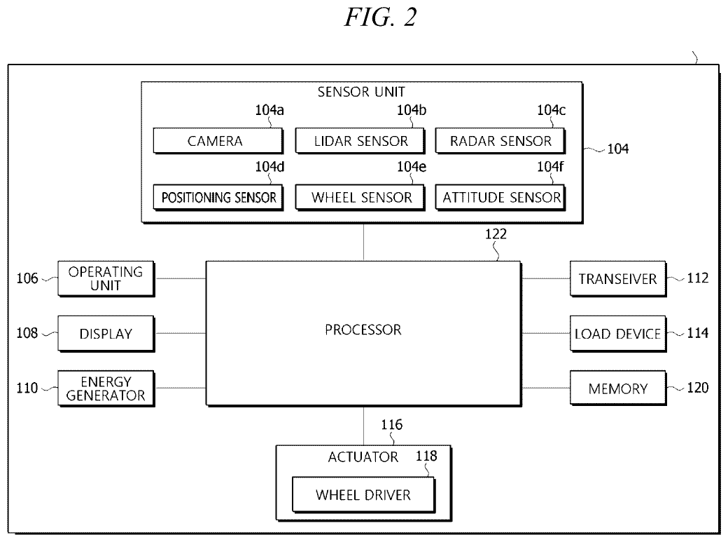

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen, but various other gases may also be applicable. In the case of fossil energy, the vehicle 100 may be driven based on fuels such as gasoline, diesel, or liquefied gas, and it may be equipped with an internal combustion engine that drives an actuator 116 (see FIG. 2) by burning the fuel. The engine may be included in an energy generator 110 (see FIG. 2) in terms of providing rotational driving force to the wheel driver 118 (see FIG. 2). As another example, the vehicle 100 may be a hybrid type vehicle selectively utilizing the energy of a fossil fuel-based internal combustion engine and an electric battery to drive the actuating unit or the actuator 116.

The vehicle 100 may refer to a movable device. The vehicle 100 may be a ground vehicle, such as a typical passenger or commercial vehicle, or a purpose-built vehicle (PBV) for specific purposes. The vehicle 100 may be a four-wheeled vehicle, such as a passenger car, sport utility vehicle (SUV), or small truck, or a vehicle with more than four wheels, such as a bus, large truck, container carrier, or heavy equipment. The vehicle 100 may also be a robot in the broad sense of a movable means, and the robot may move using wheels, tracks, or other mobility modules.

The vehicle 100 may be controlled and driven autonomously, and autonomous driving may be implemented as semi-autonomous driving or fully autonomous driving. Fully autonomous driving may be provided as autonomous movement in which the processor 122 (see FIG. 2) of the vehicle 100 fully controls the driving without user intervention, even in uncertain driving conditions. Semi-autonomous driving may be provided as autonomous movement that requires driver intervention in specific driving situations. Semi-autonomous driving may be implemented to enable manual driving by transferring control to the user when the processor 122 deactivates autonomous driving upon occurrence of such situations. According to the autonomous driving levels defined by the Society of Automotive Engineers (SAE), semi-autonomous driving may correspond to levels 1 to 4, and fully autonomous driving may correspond to level 5.

The vehicle 100 may perform communication with other devices 200, 300, or other vehicles 150. The other devices may include, for example, a server 200 supporting various control state management and driving of the vehicle 100, an Intelligent Transportation System (ITS) device 300 for receiving information from ITS, and various types of user devices. The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100.

The ITS device 300, for instance, may be a Road Side Unit (RSU). The ITS device 300 may exchange vehicle perception data, driving control and state data, environmental data around the vehicle, and map data with the vehicle 100 through Vehicle-to-Infrastructure (V2I) communication to assist the user's driving or support autonomous driving of the vehicle 100. The vehicle 100 may support manual or autonomous driving by exchanging the aforementioned data with other vehicles 150 through Vehicle-to-Vehicle (V2V) communication.

The vehicle 100 may perform communication with other vehicles or devices based on cellular communication, Wireless Access in Vehicular Environment (WAVE) communication, Dedicated Short Range Communication (DSRC), or other communication methods. For instance, the vehicle 100 may use communication networks such as long-term evolution (LTE) or fifth generation (5G), Wi-Fi networks, or wireless access in vehicular environments (WAVE) networks for communication with the server 200, ITS device 300, and other vehicles 150. In another example, DSRC used in the vehicle 100 may be utilized for inter-vehicle communication. The communication methods among the vehicle 100, the server 200, the ITS device 300, other vehicles 150, and user devices are not limited to the above-described examples.

FIG. 2 is a diagram showing an example of modules constituting a vehicle according to one example of the present disclosure.

The vehicle 100 may include a sensor unit 104, an operating unit 106, a display 108, a load device 114, and a transceiver 112.

The sensor unit 104 may be equipped with various types of detectors to sense various states and situations occurring in the external environment, internal system, user operations, and passenger space of the vehicle 100. Specifically, the sensor unit 104 may include external-facing cameras 104a, light detection and ranging (LIDAR) sensors 104b, radar sensors 104c, and the like to recognize dynamic and static objects existing outside the vehicle 100. The camera 104a may recognize external objects as images during the use of the vehicle 100, generate image data, and transmit the image data to the processor 122. The LIDAR sensor 104b may generate point cloud data as recognized data of external objects to generate three-dimensional spatial information identifying the shape of at least the external objects and transmit the point cloud data to the processor 122. The radar sensor 104c may generate radar data by emitting radio waves of a specific frequency around the vehicle 100 and recognizing the external objects through the reflected radio waves to identify the presence, relative distance, speed, and direction of external objects. Although the present disclosure illustrates including the LIDAR sensor 104b, it may not be included in other examples.

The sensor unit 104 may include a positioning sensor 104d, wheel sensor 104e, and attitude sensor 104f to confirm its position, speed, and driving posture. The attitude sensor 104f may include a gyro sensor, angular velocity sensor, accelerometer, and the like.

In the present disclosure, the sensor unit 104 includes sensors mainly referenced in the description of the examples but may further include sensors detecting various situations not listed herein.

The operating unit 106 may be configured as a module for user control for driving. For instance, the operating unit 106 may include a steering wheel for manual driving, an automatic or manual transmission actuator, an accelerator pedal, a brake pedal, a gearbox, and the like. The operating unit 106 may further include an interface for the use/deactivation of the autonomous driving mode requested by the user and the selection of detailed function to utilize the autonomous driving function. The operating unit 106 may be configured as a hard-type interface provided at a predetermined position inside the vehicle 100 or a soft-type interface touchable on the display 108 to receive various requests related to autonomous driving.

The display 108 may function as a user interface. The display 108 may display the operation state, control state, route/traffic information, remaining energy information, and contents requested by the driver of the vehicle 100 as controlled by the processor 122. The display 108 may also receive driver's requests instructing the processor 122 by being configured as a touch screen detecting driver input.

The load device 114 may be mounted on the vehicle 100 and be a kind of electric device for non-driving use, excluding the driving power system such as the wheel driver 118. The load device 114 may be an auxiliary device supplied with power from the energy generator 110, such as an air conditioning system, lighting system, seat system, and various devices installed in the vehicle 100.

The transceiver 112 may support mutual communication with the server 200, ITS device 300, and surrounding vehicles 150. The transceiver 112 may include modules handling cellular communication, WAVE, DSRC communication, and the like. For instance, the transceiver 112 may transmit data generated or stored during driving to the server 200 and receive data and software modules transmitted from the server 200. The transceiver 112 may also support communication with electronic devices carried by passengers inside the vehicle 100. In the present disclosure, the vehicle 100 may transmit and receive data utilized in the methods according to the present disclosure through the transceiver 112.

The vehicle 100 may also include an energy generator 110 and an actuating unit or actuator 116.

The energy generator 110 may generate and supply power and electricity used in the driving power system, such as the actuating unit 116, and the non-driving power system. The non-driving power system may include, for example, the sensor unit 104, operating unit 106, display 108, load device 114, transceiver 112, and the like, and may include various components implementing sensing, interface, communication, and convenience functions, excluding components directly involved in driving operations. When the vehicle 100 is driven based on electric energy, the energy generator 110 may be configured as an electric battery charged from an external source or a combination of an electric battery and a fuel cell charging the battery. In the case of a combination of an electric battery and a fuel cell, the energy generator 110 may include a tank storing a material, such as liquefied hydrogen, used to generate power in the fuel cell. When the vehicle 100 is driven based on fossil energy, the energy generator 110 may be configured as an internal combustion engine. Additionally, when the vehicle 100 is of a hybrid type, the energy generator 110 may be provided as a combination of an internal combustion engine and an electric battery.

The actuator 116 may include at least one module implementing driving operations and may perform at least one of longitudinal control, such as acceleration and deceleration, and lateral control, such as steering, based on user requests from the operating unit 106. The actuator 116 may include mechanical components and electronic modules implementing driving operations in the wheel driver 118 to perform driving operations according to commands of the processor 122 for manual control or autonomous driving. When the vehicle 100 is operated based on electric energy, it may include an assembly for delivering the requested driving operations to the wheel driver 118. When the vehicle 100 is operated based on fossil energy, the actuator 116 may include a transmission gear module delivering the power of the internal combustion engine.

The wheel driver 118 may include a driving force generating module generating driving force for multiple wheels or transferring driving force to the wheels, a braking module decelerating the driving of the wheels, and a steering module realizing lateral control of the wheels. When the vehicle 100 is driven based on electric energy, the driving force generating module may be configured as a motor assembly generating driving force based on the power output from the electric battery. The braking module of the electric-based vehicle 100 may further have a regenerative braking function.

In addition, the vehicle 100 may include a memory 120 and a processor 122.

The memory 120 may store applications and various data for controlling the vehicle 100, and load applications or read and record data by a request of the processor 122. In the present disclosure, the memory 120 may store an application and at least one instruction for determining a traffic congestion situation for a driving area of the autonomous vehicle 100 and generating congestion control information based on the traffic congestion situation. In addition, the memory 120 may generate final longitudinal control information based on various data including congestion control information and hold applications and instructions for controlling the vehicle 100 in the traffic congestion situation according to the information.

The longitudinal control may be control related to a speed, an acceleration, and a relative distance to a surrounding vehicle of the vehicle 100. As one example, the longitudinal control may be motion control in autonomous driving. As another example, the longitudinal control may be used in manual driving as well as autonomous driving. When there is a manual operation that is different from an operation appropriate for the surrounding situation, the processor 122 may intervene in manual driving with the longitudinal control that matches the surrounding situation, or may provide longitudinal control-related data to a manual driver.

Accordingly, as one example, the longitudinal control information may include a speed and an acceleration applied to the vehicle 100. The speed and the acceleration may be generated as longitudinal data that applies to any one of a time range, a distance range, or a specific section along a route. The longitudinal control information may be described as profiles of continuous velocity and acceleration over the range or section. As another example, in addition to the speed and the acceleration, the longitudinal control information may further include control factors applied to the vehicle 100, for example, control according to a relative required distance to surrounding vehicles.

The memory 120 may manage road information, surrounding object information, and vehicle information to generate final longitudinal control information depending on the presence or absence of the traffic congestion situation.

The road information may include lane level route information, road restriction information, a road structure, a traffic sign information, and road event information related to the driving lane in which the vehicle 100 moves and surrounding lanes. In the present disclosure, the road on which the vehicle 100 moves may have a plurality of lanes, and may specifically include a driving lane on which the vehicle 100 travels and surrounding lanes near the driving lane. The lane level route information may be obtained from lane images or map information acquired from, for example, the camera 104a. The map information is, for example, a lane-level precision map, and may be obtained from an external device such as the server 200 and managed in the memory 120. The lane level route information may include a trajectory (or route) of each lane, its width, parameters applied to functions related to each lane, and the like. The road restriction information may be a speed limit required on the road on which the vehicle 100 is traveling and a vehicle behavior required to comply with regulations related to the corresponding road. The traffic sign information may be information related to traffic control and guidance displayed on a road surface and signs installed on the road. The traffic sign information may include, for example, crosswalks, stop lines, U-turns, left turns, speed limits, milestones, and the like.

The road structure may be related to a road shape. The road structure may include information representing, for example, the number of lanes, a road geometry such as a straight or curved line, a road merging section, a road branch section, a road gradient, a tunnel section, road three-dimensionality (e.g., a ground road and an elevated road), and the like. The road event information may be information related to an event on the road. The road event information may include, for example, a construction zone, road event information, and a slow-speed section due to bad weather.

The surrounding object information may include data related to the behavior of dynamic objects around the vehicle 100. The surrounding object information is behavior data derived by analyzing dynamic objects obtained from at least one of the sensor unit 104, the intelligence transportation system (ITS) device 300, and other vehicles 100 by the processor 122, and the behavior data may be managed in the memory 120. Dynamic objects may be, for example, surrounding vehicles, pedestrians, or other types of mobility, and other types of mobility may be personal mobility such as bicycles or electric scooters. The behavior of the dynamic object may include information related to the position, speed, motion, or the like, of the dynamic object. The speed may include, for example, the speed of each surrounding vehicle and the average speed of surrounding vehicles in a predetermined area. The motion may be defined based on a movement pattern of the dynamic object. Taking a vehicle as an example, the motion may be referred to as a driving motion of the vehicle, and the driving motion may be divided into lane keeping driving and biased driving. The lane keeping driving may be a motion in which surrounding vehicles substantially travel along center areas of their own lanes without deviating from the lanes, thereby causing no interference with the driving of the host vehicle traveling in the adjacent lane. The bias driving may be a motion in which a surrounding vehicle does not deviate from its own lane, but travels eccentrically from the center area and approaches the driving lane used by the host vehicle or some of surrounding vehicles deviate from their own lanes and enter the lane of the host vehicle, thereby causing interference with the driving of the host vehicle.

The vehicle information may refer to information related to the vehicle according to an example of the present disclosure. The vehicle information may include data related to a longitudinal state of the vehicle 100, a sensing detection range of the surrounding environment of the sensor unit 104 mounted on the vehicle 100, and autonomous driving control. The longitudinal state may include a driving lane, a position, a speed, an acceleration, and a distance to a surrounding vehicle of the vehicle 100, and may be acquired by the camera 104a, the positioning sensor 104d, the wheel sensor 104e, the attitude sensor 104f, the radar sensor 104c, and the like, and managed in the memory 120. The sensing detection range may be a distance and an area detected by the detection performance of the sensor unit 104 that varies depending on the road shape, weather, or the like. The road shape and weather may be confirmed by road information, surrounding situations detected by the sensor unit 104, and external information provided by the server 200 or the like. Specifically, the detection range of the camera 104a, the LIDAR sensor 104b, and the radar sensor 104c varies depending on a gradient of a front road and the weather, and the variable detection range may be managed in the memory 120 as the sensing detection range. As another example, the detection range according to the gradient and weather may be stored in the memory 120 in a pre-tabulated form.

The data related to autonomous driving control may include a control plan according to various driving situations of the vehicle 100. The driving situation may be, for example, evasive driving, following a preceding vehicle, changing lanes, driving at an intersection, or the like. In the present disclosure, the data may be described mainly in terms of a control plan (or an action plan) related to control transfer from autonomous driving to manual driving among various driving situations, but is not limited thereto. The action plan may be a plan to reduce instability due to the control transfer, that is, the risk of autonomous driving. When a driving situation that the processor 122 cannot handle occurs, the action plan related to the control transfer may include, for example, a control to notify a user of the transfer in advance and move the vehicle 100 to a safe area on the road at a specific speed and stop the vehicle 100 when the user does not operate the vehicle 100 for a specified period of time after the notification. The transfer-related action plan is not limited to the above-described examples and may be established using various methods and speeds.

The map information stored in the memory 120 may be used to generate a driving route set in the vehicle 100 by the request of the user or the processor 122. In addition, the map information is utilized for autonomous driving, and may include a low-precision map or include a high-precision map together with the map. The map information may be provided to have various information and data included in driving environment information.

The processor 122 may perform overall control of the vehicle 100. The processor 122 may be configured to execute applications and instructions stored in the memory 120.

Hereinafter, a detailed configuration of a processor and a memory for autonomous driving control of a vehicle is described.

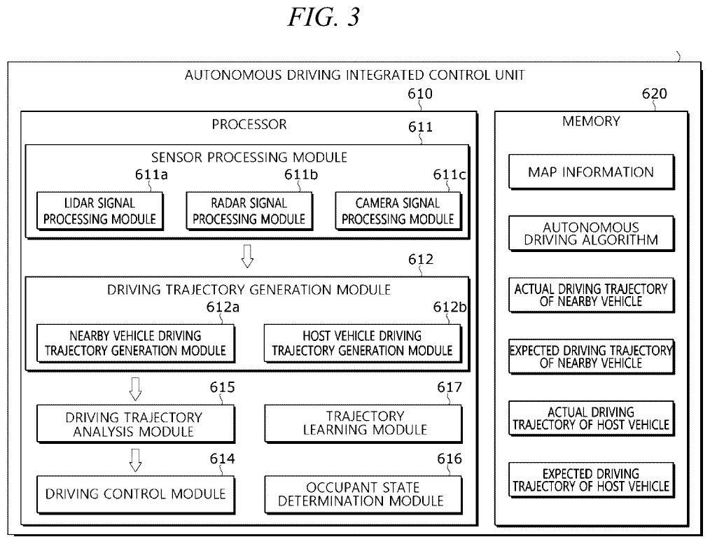

FIG. 3 is a block diagram illustrating an example of a detailed configuration of a processor and a memory for autonomous driving control in an autonomous driving device according to an example of the present disclosure.

Referring to FIG. 3, a memory 620 may store basic information necessary for autonomous driving control of a vehicle or information generated when autonomous driving of the vehicle is controlled by a processor 610, and the processor 610 may access (read) the information stored in the memory 620 to control the autonomous driving of the vehicle. The memory 620 may be implemented as a computer-readable recording medium and may operate so that the processor 610 may access the memory. Specifically, the memory 620 may be implemented as a hard drive, a magnetic tape, a memory card, a read only memory (ROM), a random-access memory (RAM), or an optical data storage device such as a digital video disc (DVD) or an optical disc.

The memory 620 may store map information required for autonomous driving control in the processor 610. The map information stored in the memory 620 may be a navigation map (digital topographic map) that provides information in road units, but may be implemented as a precision road map that provides road information in lane units in order to improve the precision of autonomous driving control, i.e., 3D high-precision electronic map data. Accordingly, the map information stored in the memory 620 may provide dynamic and static information necessary for the autonomous driving control of the vehicle, such as lanes, lane centerlines, regulatory lines, road boundaries, road centerlines, traffic signs, road surface signs, road shapes and heights, and lane widths.

Further, the memory 620 may store an autonomous driving algorithm for the autonomous driving control of the vehicle. The autonomous driving algorithm is an algorithm (e.g., recognition, determination, and control algorithm) for recognizing surroundings of the autonomous vehicle, determining a state thereof, and controlling the driving of the vehicle based on a result of the determination, and the processor 610 may execute the autonomous driving algorithm stored in the memory 620 to perform active autonomous driving control in the surrounding environment of the vehicle.

The processor 610 may control autonomous driving of the vehicle based on driving information and traveling information input from the interface provided through the display 108 described above, information on nearby objects detected through the sensor unit 104, the map information and the autonomous driving algorithm stored in the memory 620. The processor 610 may be implemented as an embedded processor such as a complex instruction set computer (CISC) or a reduced instruction set computer (RISC), or a dedicated semiconductor circuit such as an application specific integrated circuit (ASIC).

In the present example, the processor 610 may analyze respective driving trajectories of the host vehicle and a nearby vehicle to control autonomous driving of the host vehicle, and to this end, the processor 610 may include a sensor processing module 611, a driving trajectory generation module 612, a driving trajectory analysis module 613, a driving control module 614, a trajectory learning module 615, and an occupant state determination module 616, as illustrated in FIG. 3. Although FIG. 3 illustrates respective modules as independent blocks according to their functions, the modules may be integrated into one module to perform respective functions in an integrated manner.

The sensor processing module 611 may determine driving information of the nearby vehicle (i.e., which includes a position of the nearby vehicle and may further include a speed and moving direction of the nearby vehicle together with the position) based on a result of detecting a vehicle near the host vehicle through the sensor unit 104. In other words, the sensor processing module 611 may determine the position of the nearby vehicle based on a signal received through a lidar sensor 104b, may determine the position of the nearby vehicle based on a signal received through the radar sensor 104c, or may determine the position of the nearby vehicle based on an image captured through the camera 104a. A method of determining the position of the nearby vehicle by utilizing the lidar sensor 104b, the radar sensor 104c, and the camera 104a is a specific example, and an implementation scheme therefor is not limited. Further, the sensor processing module 611 may determine attribute information such as a size and type of the nearby vehicle as well as the position, speed, and moving direction of the nearby vehicle, and an algorithm for determining information such as the position, speed, moving direction, size, and type of the nearby vehicle as described above may be defined in advance.

The driving trajectory generation module 612 may generate the actual driving trajectory and expected driving trajectory of the nearby vehicle and the actual driving trajectory of the host vehicle, and to this end, the driving trajectory generation module 612 may include a nearby vehicle driving trajectory generation module 612a and a host vehicle driving trajectory generation module 612b, as illustrated in FIG. 3.

First, the nearby vehicle driving trajectory generation module 612a may generate the actual driving trajectory of the nearby vehicle.

Specifically, the nearby vehicle driving trajectory generation module 612a may generate the actual driving trajectory of the nearby vehicle based on the driving information of the nearby vehicle detected by the sensor unit 104 (i.e., the position of the nearby vehicle determined by the sensor processing module 611). In this case, in order to generate the actual driving trajectory of the nearby vehicle, the nearby vehicle driving trajectory generation module 612a may refer to the map information stored in the memory 620, and may generate the actual driving trajectory of the nearby vehicle by cross-referencing the position of the nearby vehicle detected by the sensor unit 104 and an arbitrary position in the map information stored in the memory 620. For example, when the nearby vehicle is detected at a specific point by the sensor unit 104, the nearby vehicle driving trajectory generation module 612a may specify the position of the currently detected nearby vehicle in the map information by cross-referencing the position of the detected nearby vehicle and the arbitrary position in the map information stored in the memory 620, and may generate the actual driving trajectory of the nearby vehicle by continuously monitoring the position of the nearby vehicle as described above. In other words, the nearby vehicle driving trajectory generation module 612a may generate the actual driving trajectory of the nearby vehicle by mapping the position of the nearby vehicle detected by the sensor unit 104 to a position in the map information stored in the memory 620 based on the cross-reference and accumulating the position.

The actual driving trajectory of the nearby vehicle may be compared with the expected driving trajectory of the nearby vehicle to be described below and utilized to determine whether the map information stored in the memory 620 is inaccurate. In this case, when an actual driving trajectory of a specific nearby vehicle is compared with an expected driving trajectory, a problem that the map information is incorrectly determined to be inaccurate even though the map information is accurate may occur. For example, when an actual driving trajectory and an expected driving trajectory of a number of nearby vehicles match, but an actual driving trajectory and an expected driving trajectory of any specific nearby vehicle do not match, comparing only the actual driving trajectory of the specific nearby vehicle with the expected driving trajectory may lead to an incorrect determination that the map information is inaccurate even though the map information is accurate. Therefore, it is necessary to determine whether actual driving trajectories of a plurality of nearby vehicles tend to deviate from expected driving trajectories, and to this end, the nearby vehicle driving trajectory generation module 612a may generate respective actual driving trajectories of the plurality of nearby vehicles. Further, considering that a driver of the nearby vehicle tends to slightly move a steering wheel left and right during a driving process for driving on a straight path, the actual driving trajectory of the nearby vehicle may be generated in a curved form rather than a straight form, and in order to calculate an error between the actual driving trajectory and an expected driving trajectory to be described later, the nearby vehicle driving trajectory generation module 612a may apply a predetermined smoothing scheme to a raw actual driving trajectory generated in a curved form to generate the actual driving trajectory in a straight shape. Any scheme such as interpolation for each position of the nearby vehicle may be employed as the smoothing scheme.

Further, the nearby vehicle driving trajectory generation module 612a may generate the expected driving trajectory of the nearby vehicle based on the map information stored in the memory 620.

As described above, the map information stored in the memory 620 may be three-dimensional high-precision electronic map data, and thus the map information may provide dynamic and static information necessary for autonomous driving control of the vehicle, such as lanes, lane centerlines, regulatory lines, road boundaries, road centerlines, traffic signs, road surface signs, road shapes and heights, and lane widths. Considering that a vehicle generally drives at a center of a lane, it may be expected that a nearby vehicle near the host vehicle will also travel at the center of the lane, and therefore, the nearby vehicle driving trajectory generation module 612a may generate the expected driving trajectory of the nearby vehicle as a lane centerline reflected in the map information.

The host vehicle driving trajectory generation module 612b may generate the actual driving trajectory along which the host vehicle has driven so far, based on the driving information of the host vehicle acquired through the interface provided through the display 108.

The host vehicle driving trajectory generation module 612b may generate the actual driving trajectory of the host vehicle by cross-referencing the position of the host vehicle acquired through the interface provided through the display 108 (i.e., the position information of the host vehicle acquired through a global positioning system (GPS) receiver) and an arbitrary position in the map information stored in the memory 620. For example, the current position of the host vehicle may be specified in the map information by cross-referencing the position of the host vehicle acquired through the interface provided through the display 108 and the arbitrary position in the map information stored in the memory 620, and the actual driving trajectory of the host vehicle may be generated by continuously monitoring the position of the host vehicle as described above. In other words, the host vehicle driving trajectory generation module 612b may generate the actual driving trajectory of the host vehicle by mapping the position of the host vehicle acquired through the interface provided through the display 108 to the position in the map information stored in the memory 620 based on the cross-reference and accumulating the position.

Further, the host vehicle driving trajectory generation module 612b may generate the expected driving trajectory along which the host vehicle should drive to the destination based on the map information stored in the memory 620.

In other words, the host vehicle driving trajectory generation module 612b may generate the expected driving trajectory to the destination by using the current position of the host vehicle acquired through the interface (i.e., current position information of the host vehicle acquired through the GPS receiver) and the map information stored in the memory, and the expected driving trajectory of the host vehicle may be generated as a lane center line reflected in the map information stored in the memory 620, like the expected driving trajectories of the nearby vehicle.

The driving trajectories generated by the nearby vehicle driving trajectory generation module 612a and the host vehicle driving trajectory generation module 612b may be stored in the memory 620 and may be utilized for various purposes when the processor 610 controls autonomous driving of the host vehicle.

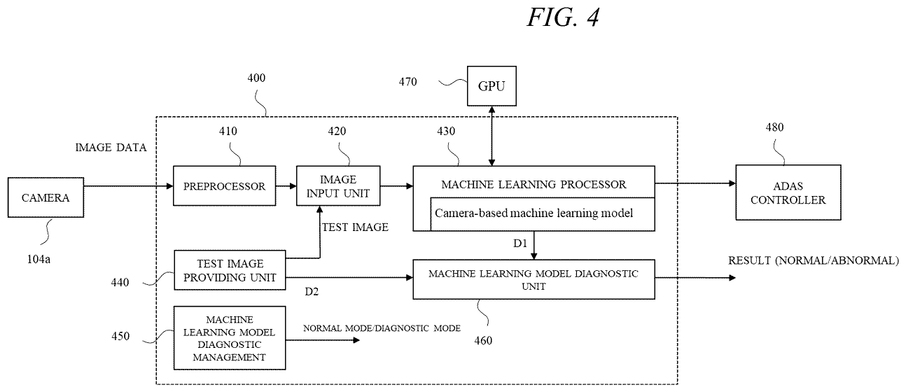

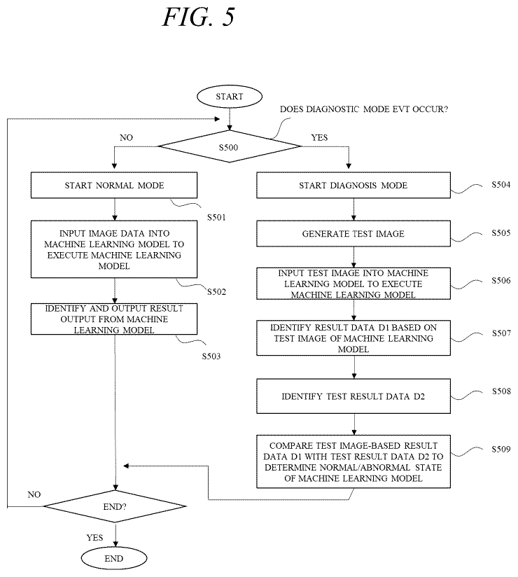

Further, the nearby vehicle driving trajectory generation module 612a tracks a state trajectory of a target object near the host vehicle estimated from a position measurement value obtained by detecting the target object, and a detailed operation of tracking the state trajectory of the target object according to the example of the present disclosure is described in detail with reference to FIGS. 4 and 5 below.

The driving trajectory analysis module 613 may diagnose current reliability of the autonomous driving control for the host vehicle by analyzing respective driving trajectories (that is, the actual driving trajectory and expected driving trajectory of the nearby vehicle, and the actual driving trajectory of the host vehicle) generated by the driving trajectory generation module 612 and stored in the memory 620. The diagnosis of the reliability of the autonomous driving control may be performed by analyzing a trajectory error between the actual driving trajectory and the expected driving trajectory of the nearby vehicle.

The driving control module 614 may perform a function of controlling autonomous driving of the host vehicle, and specifically, the driving control module 614 may comprehensively use driving information and traveling information input from the interface provided through the display 108 described above, information on nearby objects detected through the sensor unit 104, and the map information stored in the memory 620 to process the autonomous driving algorithm, and transfer control information through the interface provided through the display 108 to cause a low-level control system to control autonomous driving of the host vehicle. Further, when the driving control module 614 controls the autonomous driving as described above in an integrated manner, the driving control module 614 controls the autonomous driving in consideration of the driving trajectories of the host vehicle and the nearby vehicle analyzed by the sensor processing module 611, the driving trajectory generation module 612, and the driving trajectory analysis module 613 described above, thereby improving the precision and stability of the autonomous driving control.

The trajectory learning module 615 may perform learning or correction on the actual driving trajectory of the host vehicle generated by the host vehicle driving trajectory generation module 612b. For example, when the trajectory error between the actual driving trajectory and the expected driving trajectory of the nearby vehicle is equal to or greater than a preset threshold value, it may be determined that the map information stored in the memory 620 is inaccurate and the actual driving trajectory of the host vehicle needs to be refined, and accordingly, a lateral shift value for correcting the actual driving trajectory of the host vehicle may be determined so that the driving trajectory of the host vehicle can be refined.

The occupant state determination module 616 may determine a state and behavior of an occupant based on a state and bio signal of an occupant detected by an internal camera sensor and a biosensor. The occupant state determined by the occupant state determination module 616 may be utilized when the autonomous driving of the host vehicle is performed or a warning is output to the occupant.

Conventional camera-based machine learning models lack a means for real-time detection of tampering or defects that may occur during the process of downloading or storing the model in a vehicle. This technical deficiency can cause the ADAS controller to malfunction, potentially leading to accidents or safety hazards during autonomous driving.

The present disclosure provides a diagnostic apparatus and method that automatically detects tampering or malfunction of a camera-based machine learning model by quantitatively comparing and verifying the output results of the model against pre-stored test result data using test images. This represents not merely a method of processing data, but a technical improvement that substantially enhances the reliability of the autonomous driving system by operating in close coordination with specific hardware components of the system, including a GPU, a processor, and a memory.

Hereinafter, the configuration and operation of a camera-based machine learning model diagnostic apparatus according to an example of the present disclosure is described in detail.

FIG. 4 is a diagram illustrating an example of components of a camera-based machine learning model diagnostic apparatus according to an example of the present disclosure.

Referring to FIG. 4, a camera-based machine learning model diagnostic apparatus 400 may be included in a camera signal processing module 611c.

The camera-based machine learning model diagnostic apparatus 400 may include a preprocessor 410, an image input unit 420, a machine learning processor 430, a test image providing unit 440, a machine learning model diagnostic management unit 450, and a machine learning diagnostic unit 460.

The preprocessor 410 receives video data (or image data) processed by an image signal processor of a camera 104a and converts the received image data into a format suitable for a machine learning model to provide the converted-format data to the machine learning processor 430.

The image input unit 420 may select an image to be input to the machine learning processor 430 and generate an input path of the image. For example, the image input unit 420 may be configured to provide the image data input via the preprocessor 410 to the machine learning processor 430, or to provide test image data supplied from the test image providing unit 440 to the machine learning processor 430.

The machine learning processor 430 may control the operation of a camera-based machine learning model. For example, the machine learning processor 430 may input image data or test image data into the camera-based machine learning model and request execution of the camera-based machine learning model. The operation of the camera-based machine learning model may be performed via a GPU 470, and the machine learning processor 430 may provide the image data or test image data to the GPU 470 and request execution of the camera-based machine learning model. The execution result data of the camera-based machine learning model may be provided to the machine learning processor 430, and the machine learning processor 430 may be configured to output the execution result data.

For example, the camera-based machine learning model may be a model that performs camera-based object detection, detection of the location of a detected object, classification of the type of the detected object, and the like. The execution result data may include, for example, a camera-based object identifier, location information of the detected object, information representing the area of the detected object, and type information of the detected object.

Furthermore, the machine learning processor 430 may provide the execution result data of the camera-based machine learning model to an advanced driver assistance system (ADAS) controller 480, and the ADAS controller 480 may, based on the received data, generate an autonomous driving route or control the steering or driving of an autonomous vehicle.

In the case of a machine learning model, even when the machine learning model outputs normal results in the learning environment, defects may occur during the process in which the machine learning model is downloaded to or stored in the vehicle. When the machine learning model is altered in this way and errors occur during execution of the machine learning model in the vehicle, or when the output information is inaccurate, the ADAS controller 480, which uses the execution result data of the camera-based machine learning model, may malfunction, potentially causing accidents or other problems while the autonomous vehicle is driving. To address such issues, the camera-based machine learning model diagnostic apparatus 400 may include the image input unit 420, the test image providing unit 440, the machine learning model diagnostic management unit 450, and the machine learning diagnostic unit 460.

The machine learning model diagnostic management unit 450 may determine whether to perform a diagnosis of a camera-based machine learning model. The diagnosis of the camera-based machine learning model may be performed based on information input by a user. Accordingly, the machine learning model diagnostic management unit 450 may provide, via a display or the like, a GUI environment through which a diagnostic request for the camera-based machine learning model can be input by the user. When the diagnostic request for the camera-based machine learning model is received from the user through an input device, the machine learning model diagnostic management unit 450 may operate in a diagnostic mode.

As another example, the diagnosis of the camera-based machine learning model may be performed after the camera-based machine learning model has been embedded or updated in the vehicle. Accordingly, the machine learning model diagnostic management unit 450 may determine whether the camera-based machine learning model is embedded or updated in the vehicle and perform the diagnostic mode after the embedding or the updating. In yet another example, the diagnosis of the camera-based machine learning model may be configured to perform the diagnostic mode at predetermined intervals after the camera-based machine learning model has been embedded in the vehicle.

The test image providing unit 440 may output a test image prepared for diagnosing the camera-based machine learning model, and the output test image may be provided to the image input unit 420. In addition, the test image providing unit 440 may store test result data corresponding to the test images and provide the test result data to the machine learning diagnostic unit 460.

The image input unit 420 may control an image input in a normal mode and an image input in a diagnostic mode to be input differently. For example, in the normal mode, the image input unit 420 may provide video data (or image data) processed by the image signal processor of the camera 104a to the machine learning processor 430. In contrast, when the camera-based machine learning model diagnostic apparatus 400 operates in the diagnostic mode of the machine learning model, the image input unit 420 may provide the test image supplied from the test image providing unit 440 to the machine learning processor 430.

The machine learning diagnostic unit 460 may determine whether the camera-based machine learning model is faulty or malfunctioning by comparing test image-based result data D1, obtained by inputting the test image into the machine learning model and processing the test image, with test result data D2 provided from the test image providing unit 440.

For example, the test image-based result data D1 and the test result data D2 compared by the machine learning diagnostic unit 460 may include a feature map of an image, a 2D box of an image recognition result, a 3D cuboid of an image recognition result, and an image processing execution time. For example, when the test image-based result data D1 and the test result data D2 are the same, the machine learning diagnostic unit 460 may determine that the camera-based machine learning model is normal. When the test image-based result data D1 and the test result data D2 are different from each other, the machine learning diagnostic unit 460 may determine that the camera-based machine learning model is abnormal.

As another example, the machine learning diagnostic unit 460 may calculate an error rate using test image-based result data D1 and test result data D2 and compare the calculated error rate with a predetermined threshold value (error rate) to determine whether the camera-based machine learning model is normal or abnormal.

For example, the machine learning diagnostic unit 460 may calculate the error rate through the following Equation 1.

$$Error rate = \frac{B / Box ( 2 D ) Ovelapping Area Size}{B / Box ( 2 D ) Entire Area Size} \times 100 \qquad Equation 1$$

The size of the entire area of B/Box (2D) (i.e., B/Box (2D) Entire Area Size in Equation 1) may be the sum of the size of the area of the test image-based result data and the area of the test result data.

When the error rate calculated through Equation 1 described above exceeds a predetermined threshold value (e.g., 95%), the machine learning diagnostic unit 460 may determine that the camera-based machine learning model is normal (i.e., a first state that satisfies a predetermined condition to determine that the state of the camera-based machine learning model is normal). When the calculated error rate is less than or equal to the predetermined threshold value (e.g., 95%), the machine learning diagnostic unit 460 may determine that the camera-based machine learning model is abnormal (i.e., a second state that fails to satisfy the predetermined condition).

As another example, the machine learning diagnostic unit 460 may calculate the error rate through the following Equation 2.

$$Error rate = \frac{Image Processing Time}{Reference Processing Time} \times 100 \qquad Equation 2$$

The machine learning diagnostic unit 460 may determine that the camera-based machine learning model is abnormal when the error rate calculated through Equation 2 exceeds a predetermined threshold value (e.g., 120%). The machine learning diagnostic unit 460 may determine that the camera-based machine learning model is normal when the calculated error rate is less than or equal to the predetermined threshold value (e.g., 120%).

The camera-based machine learning model diagnostic apparatus (400) of the present disclosure is configured to numerically determine whether the machine learning model is in a normal or abnormal state by calculating an error rate based on Equation 1 and Equation 2. This constitutes a specific improvement to the functioning of the autonomous driving computing system, enabling the system to autonomously diagnose and respond to anomalies in the machine learning model.

FIG. 5 is a flowchart illustrating an example of the operation of a camera-based machine learning model diagnostic method according to an example of the present disclosure.

The camera-based machine learning model diagnostic method according to the example of the present disclosure may be performed by the camera-based machine learning model diagnostic apparatus (hereinafter, “diagnostic apparatus”) described above.

Referring to FIG. 5, the diagnostic apparatus 400 may identify an operating mode. For example, in operation S500, the diagnostic apparatus 400 determine whether a diagnostic mode event occurs. The diagnostic apparatus 400 enters a diagnostic mode (S504) when a diagnostic mode event occurs (Yes in S500) and enters a normal mode (S501) when no diagnostic mode event occurs (No in S500).

In operation S501, the diagnostic apparatus 400 receives video data (or image data) processed by the image signal processor of the camera 104a in the normal mode and converts the received image data into a format (e.g., RGB format) suitable for a machine learning model.

In operation S502, the diagnostic apparatus 400 inputs the converted-format data into the camera-based machine learning model and executes the camera-based machine learning model.

Next, the diagnostic apparatus 400 may identify the execution result data output from the camera-based machine learning model and provide the identified result data to the ADAS controller 480.

For example, the camera-based machine learning model may be a model that performs camera-based object detection, detection of the location of a detected object, classification of the type of the detected object, and the like. The execution result data may include, for example, a camera-based object identifier, location information of the detected object, information representing the area of the detected object, and type information of the detected object.

In operation S504, the diagnostic apparatus 400 may switch to the diagnostic mode when the diagnostic mode event occurs. For example, the diagnostic mode event may be generated based on information input by the user. Specifically, the diagnostic apparatus 400 may provide, through a display or the like, a GUI environment in which a diagnostic request for the camera-based machine learning model can be input by the user and may generate the diagnostic mode event when receiving the diagnostic request for the camera-based machine learning model from the user via an input device.

As another example, the diagnostic apparatus 400 may generate the diagnostic mode event when the camera-based machine learning model is embedded or updated in the vehicle. As yet another example, the diagnostic apparatus 400 may generate the diagnostic mode event at predetermined intervals after the camera-based machine learning model has been embedded in the vehicle.

In the diagnostic mode, the diagnostic apparatus 400 may generate test image data in operation S505 and input the generated test image into the camera-based machine learning model to execute the operation of the machine learning model in operation S506. Next, in operation S507, the diagnostic apparatus 400 may identify result data D1 output from the camera-based machine learning model.

In addition, in operation S508, the diagnostic apparatus 400 may store the test image data together with corresponding test result data D2 and identify the test result data D2. Next, in operation S509, the diagnostic apparatus 400 may compare the result data D1 output from the camera-based machine learning model with the predetermined test result data D2 to determine the state of the machine learning model (e.g., normal state or abnormal state).

For example, when the test image-based result data D1 and the test result data D2 are the same, the diagnostic apparatus 400 may determine that the camera-based machine learning model is normal. When the test image-based result data D1 and the test result data D2 are different from each other, the diagnostic apparatus 400 may determine that the camera-based machine learning model is abnormal.

As another example, the diagnostic apparatus 400 may calculate an error rate using the test image-based result data D1 and the test result data D2 and determine whether the camera-based machine learning model is in a normal or abnormal state by comparing the calculated error rate with a predetermined threshold value (e.g., a predetermined threshold error rate value).

Through the above-described operation, the diagnostic apparatus 400 can determine whether the camera-based machine learning model is in a normal or abnormal state and also determine the state of the camera-based machine learning model as well as the state of hardware (e.g., memory, processor, GPU, and the like) that executes the camera-based machine learning model.

According to the present disclosure, by diagnosing whether a machine learning model for determining a driving situation applied to a vehicle performs inference normally, and by providing an environment in which a machine learning model that performs inference normally in the vehicle can be used, the reliability of driving situation determination can be improved.

In addition, according to the present disclosure, it is possible to diagnose whether a machine learning model for determining a driving situation is operated normally by hardware (e.g., GPU, etc.) provided in a vehicle.

Furthermore, according to the present disclosure, by identifying the state of a machine learning model for determining a driving situation applied to a vehicle, and determining the driving situation and performing autonomous driving control, the stability of autonomous driving control can be enhanced.

The diagnostic method of the present disclosure is not an abstract concept of merely comparing data, but a specific technical process carried out through the coordinated operation of particular hardware components within the camera signal processing module of an autonomous vehicle. This process achieves a technical effect of substantially improving the safety and reliability of the autonomous driving system.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative examples, the functions mentioned in the steps may occur out of order. For example, two steps illustrated in succession may in fact be performed substantially simultaneously, or the steps may sometimes be performed in a reverse order depending on the corresponding function.

The above description merely describes examples of the technical scope of the present disclosure, and it should be understood by those having ordinary skill in the art that various changes and modifications can be made without departing from original characteristics of the present disclosure. Therefore, examples disclosed in the present disclosure are intended to explain, not to limit, the technical scope of the present disclosure, and the technical scope of the present disclosure is not limited by the examples. The protection scope of the present disclosure should be interpreted based on the following claims and it should be appreciated that all technical scopes included within a range equivalent thereto are included in the protection scope of the present disclosure.

What is claimed is:

1. A machine learning model diagnostic method comprising:
preparing a camera-based machine learning model;
generating a test image that is used as an input to the camera-based machine learning model;
inputting the test image into the camera-based machine learning model;
executing the camera-based machine learning model;
determining test image-based result data output from the camera-based machine learning model;
determining test result data corresponding to the test image; and
determining a state of the camera-based machine learning model by comparing the test image-based result data with the test result data.

2. The machine learning model diagnostic method of claim 1, wherein determining the state of the camera-based machine learning model includes determining whether the test image-based result data is a same as the test result data.

3. The machine learning model diagnostic method of claim 1, wherein determining the state of the camera-based machine learning model includes:
determining an error rate based on the test image-based result data and the test result data;
comparing the determined error rate with a predetermined threshold value; and
determining, based on a result of comparing the determined error rate with a predetermined threshold value, the state of the camera-based machine learning model or a state of a processor that executes the camera-based machine learning model.

4. The machine learning model diagnostic method of claim 3, wherein determining the error rate includes:
calculating a proportion of an overlapping area between an area of an object included in the test image-based result data and an area of an object included in the test result data; and
determining the error rate based on the proportion of the overlapping area.

5. The machine learning model diagnostic method of claim 3, wherein the determining of the error rate includes
determining the error rate based on a time required to output the test image-based result data relative to a predetermined reference required time.

6. The machine learning model diagnostic method of claim 3, further comprising:
determining that the state of the camera-based machine learning model is a first state that satisfies a predetermined condition based on the error rate being greater than the predetermined threshold value.

7. A vehicle comprising:
a camera configured to detect a target object near a driving vehicle;
a memory configured to store a machine learning model diagnostic program; and
a processor, by executing the machine learning model diagnostic program, configured to:
prepare a camera-based machine learning model;
generate a test image that is used as an input to the camera-based machine learning model;
input the test image into the camera-based machine learning model;
execute the camera-based machine learning model;
determine test image-based result data output from the camera-based machine learning model;
determine test result data corresponding to the test image; and
determine a state of the camera-based machine learning model by comparing the test image-based result data with the test result data.

8. The vehicle of claim 7, wherein the processor is further configured to determine whether the test image-based result data is a same as the test result data.

9. The vehicle of claim 7, wherein the processor is further configured to:
determine an error rate based on the test image-based result data and the test result data;
compare the determined error rate with a predetermined threshold value; and
determine, based on a compared result, the state of the camera-based machine learning model or a state of hardware that executes the camera-based machine learning model.

10. The vehicle of claim 9, wherein the hardware includes the processor.

11. The vehicle of claim 9, wherein the processor is further configured to:
calculate a proportion of an overlapping area between an area of an object included in the test image-based result data and an area of an object included in the test result data; and
determine the error rate based on the proportion of the overlapping area.

12. The vehicle of claim 9, wherein the processor is further configured to determine the error rate based on a time required to output the test image-based result data relative to a predetermined reference required time.

13. The vehicle of claim 9, wherein the processor is further configured to:
determine that the state of the camera-based machine learning model is a first state that satisfies a predetermined condition based on the error rate being greater than the predetermined threshold value.

14. A non-transitory computer-readable storage medium including computer executable instructions, wherein the computer executable instructions, when executed by a processor, cause the processor to perform a machine learning model diagnostic method, the method comprising:
preparing a camera-based machine learning model;
generating a test image that is used as an input to the camera-based machine learning model;
inputting the test image into the camera-based machine learning model;
executing the camera-based machine learning model; and
determining test image-based result data output from the camera-based machine learning model;
determining test result data corresponding to the test image; and
determining a state of the camera-based machine learning model by comparing the test image-based result data with the test result data.

15. The non-transitory computer-readable storage medium of claim 14, wherein determining the state of the camera-based machine learning model includes determining whether the test image-based result data is a same as the test result data.

16. The non-transitory computer-readable storage medium of claim 14, wherein determining the state of the camera-based machine learning model includes:
determining an error rate based on the test image-based result data and the test result data;
comparing the determined error rate with a predetermined threshold value; and
determining, based on a result of comparing the determined error rate with a predetermined threshold value, the state of the camera-based machine learning model or a state of a processor that executes the camera-based machine learning model.

17. The non-transitory computer-readable storage medium of claim 16, wherein determining the error rate includes:
calculating a proportion of an overlapping area between an area of an object included in the test image-based result data and an area of an object included in the test result data; and
determining the error rate based on the proportion of the overlapping area.

18. The non-transitory computer-readable storage medium of claim 16, wherein determining the error rate includes
determining the error rate based on a time required to output the test image-based result data relative to a predetermined reference required time.

19. The non-transitory computer-readable storage medium of claim 16, wherein the method further includes:
determining that the state of the camera-based machine learning model is a first state that satisfies a predetermined condition based on the error rate being greater than the predetermined threshold value.
